(19) United States
(12) Patent Application Publication
(10) Pub. No.: US 2016/0334946 A1
(43) Pub. Date: Nov. 17, 2016

(54) METHOD FOR ADJUSTING USER INTERFACE AND ELECTRONIC DEVICE EMPLOYING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-SAN CHIANG, New Taipei (TW); WEN-WEN ZHANG, Shenzhen (CN); SHUANG HU, Shenzhen (CN); LING-JUAN JIANG, Shenzhen (CN); HUA-DONG CHENG, Shenzhen (CN)

(21) Appl. No.: 14/867,200

(22) Filed: Sep. 28, 2015

(30) Foreign Application Priority Data
May 14, 2015 (CN) 201510244636.5

(51) Int. Cl. G06F 3/0482; G06F 3/0483; G06F 3/0484; G06F 3/0481; G06F 3/0488

(52) U.S. Cl. CPC G06F 3/0482; G06F 3/04817; G06F 3/04883; G06F 3/04845; G06F 3/0483

(57) ABSTRACT

An method for adjusting user interface comprising: receiving touch signals generated by a display unit in response to operations on an application icon page displayed on the display unit; determining a touch motion according to the received touch signals; and adjusting the application icons of the application icon page when the touch motion is the sliding motion between two touch points.

### CROSS-REFERENCE TO RELATED APPLICATIONS

This application claims priority to Chinese Patent Application No. 201510244636.5 filed on May 14, 2015, the contents of which are incorporated by reference herein.

### FIELD

The subject matter herein generally relates to user interface, especially relates to a method for adjusting user interface and an electronic device employing the method.

### BACKGROUND

With the development of the electronic technology, more and more people use one or more electronic products, such as a mobile phone, a tablet computer. Many different kinds of applications installed in the electronic products enrich daily life.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device.

FIG. 2 is a diagrammatic view of an embodiment of an user interface.

FIG. 3 is a block diagram of an embodiment of a system for adjusting the user interface.

FIG. 4 is a diagrammatic view of an embodiment of the enlarged application icon on the application icon page.

FIG . 5 is a diagrammatic view of an embodiment of the narrowed application icon on the application icon page.

FIG. 6 is a diagrammatic view of an embodiment of the default region.

FIG. 7 is a flowchart of an embodiment of a method for adjusting user interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

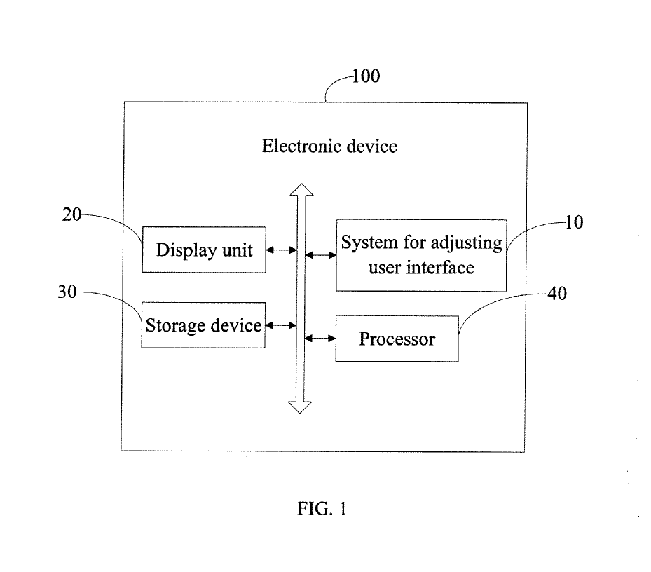

FIG. 1 illustrates a block diagram of an embodiment of an electronic device 100.

The electronic device 100 includes, but is not limited to an system 10 for adjusting user interface, a display unit 20, a storage device 30 and at least one processor 40. The system 10 can be a collection of software instructions executed by the processor 40. The electronic device 100 can be a smart phone, a tablet computer or other suitable terminal device.

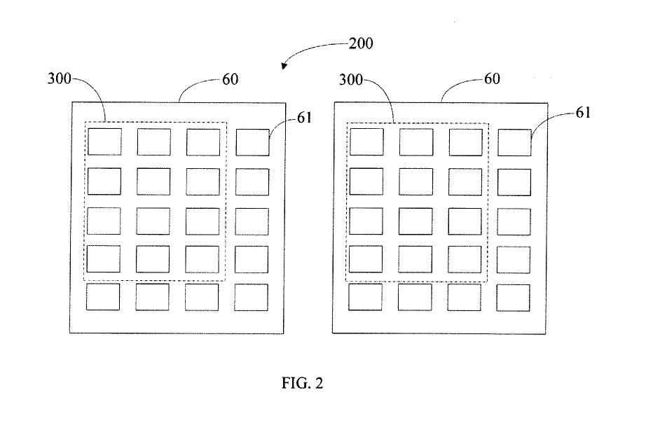

FIG. 2 illustrates a diagrammatic view of an embodiment of an user interface 200.

The display unit 20 is used to display an user interface 200. The user interface 200 includes at least one application icon page 60. Each application icon page 60 includes a number of application icons 61 arranged in a multi-row and multi-column matrix, therein each application icons 61 corresponds to an application. Each application icon page 60 also includes a predetermined region 300. The predetermined region 300 of each application icon page 60 is used to arrange partial application icons 61 of the corresponding application icon page 60. In at least one embodiment, the display unit 20 is a touch screen. The display unit 20 is able to generate touch signals in response to operations on the application icon page 60 displayed on the display unit 20.

In at least one embodiment, the storage device 30 can include various types of non-transitory computer-readable storage mediums. For example, the storage device 30 can be an internal storage system, such as a flash memory, a random access memory (RAM) for temporary storage of information, and/or a read-only memory (ROM) for permanent storage of information. The storage device 30 can also be an external storage system, such as a hard disk, a storage card, or a data storage medium. The at least one processor 40 can be a central processing unit (CPU), a microprocessor, or other data processor chip that performs functions of the system 10 for adjusting user interface 200 in the electronic device 100.

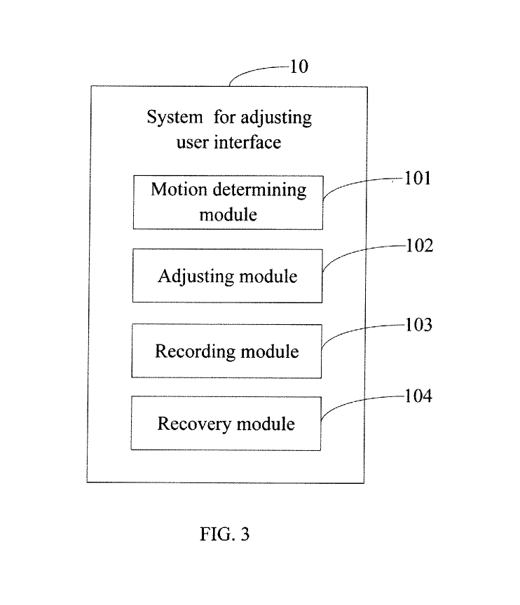

FIG. 3 illustrates a block diagram of an embodiment of the system 10 for adjusting user interface 200. In at least one embodiment, the system 10 includes an motion determining module 101, an adjusting module 102, a recording module 103, and a recovery module 104. The modules 101-104 of the system 10 can be collections of software instructions stored in the storage device 30 of the electronic device 100 and executed by the processor 40 of the electronic device 100. The modules 101-104 of the system 100 also can include functionality represented as hardware or integrated circuits, or as software and hardware combinations, such as a special-purpose processor or a general-purpose processor with special-purpose firmware.

The motion determining module 101 is used to receive the touch signals generated by the display unit 20 in response to operations on the application icon page 60 displayed on the display unit 20, and determine a touch motion according to the received touch signals.

For example, when the user touches the application icon page 60 displayed on the display unit 20 by executing a sliding motion between two touch points, the motion determining module 101 receives the touch signals generated by the display unit 20 and determines that there are two touch points whose touch positions are changing continuously on the application icon page 60 according the received touch signals. Then the motion determining module 101 determines the touch motion as the sliding motion between two touch points.

The adjusting module 102 is used to adjust the application icons 61 of the application icon page 60 when the touch motion determined by the motion determining module 101 is the sliding motion between two touch points. In the embodiment, adjusting the application icons 61 of the application icon page 60 means zooming in or out the application icons 61 of the application icon page 60 and increasing or decreasing the application icons of the application icon page 60. In at least one embodiment, when the motion determining module 101 determines that the touch motion on the current application icon page 60 is two touch points moving away from each other, the adjusting module 102 displays the application icons 61 outside of the predetermined region 300 of the current application icon page 60 on another application icon page 60, enlarges the application icons 61 of the predetermined region 300 of the current application icon page 60, displays the enlarged application icons 61 on the entire application icon page 60, and adjusts the distances among the enlarged application icons 61 displayed on the entire application icon page 60, such as increasing or decreasing the distances among the enlarged application icons 61.

In at least one embodiment, when the motion determining module 101 determines that the touch motion on the current application icon page 60 is two touch points moving toward each other, the adjusting module 102 diminishes the application icons 61 on the entire application icon page 60, displays the diminished application icons 61 on the predetermined region 300 of the application icon page 60. The adjusting module 102 also diminishes a part of the application icons 61 of another application icon page 60, displays the diminished application icons 61 of the another application icon page 60 on the remaining region outside of the predetermined region 300 of the current application icon page 60, and adjusts the distances among the diminished application icons 61 arranged on the entire current application icon page 60.

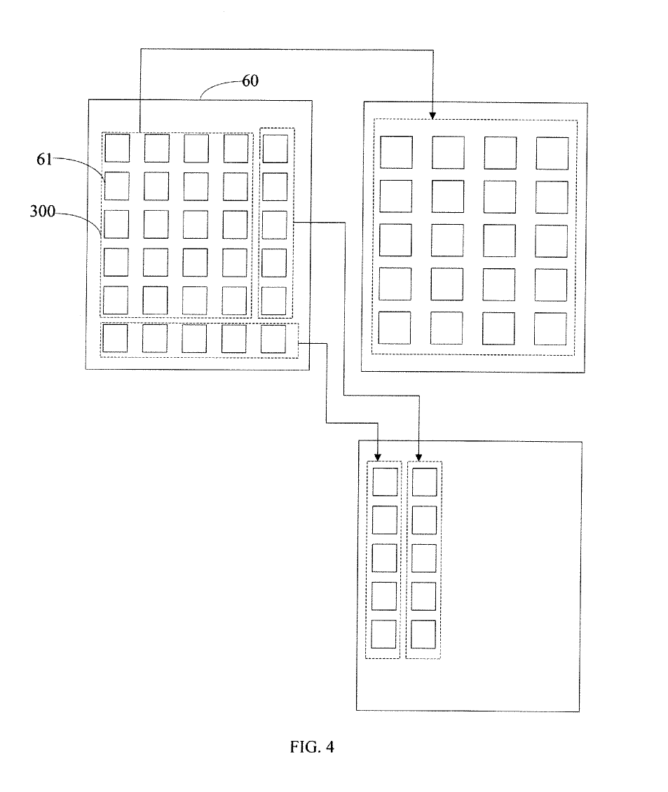

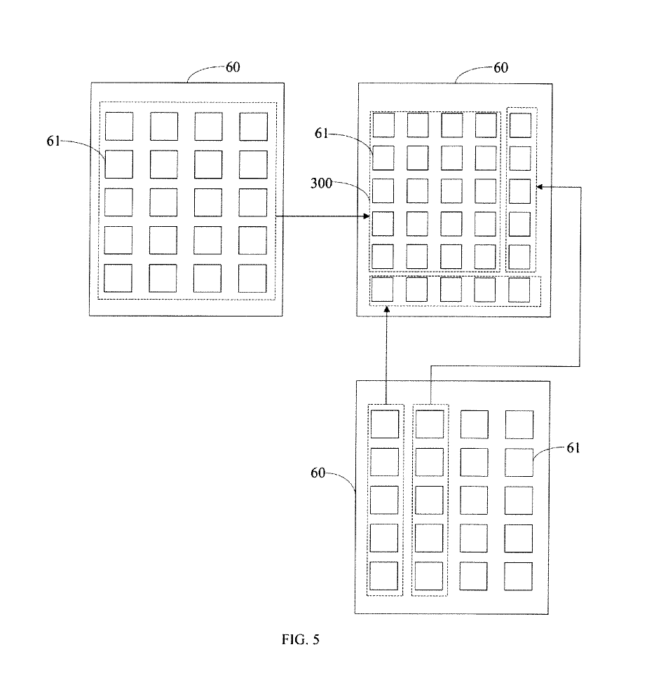

FIG. 4 illustrates a diagrammatic view of an embodiment of the enlarged application icon 61 on the application icon page 60. In detail, when the motion determining module 101 determines that the touch motion on the current application icon page 60 is two touch points moving away from each other, the adjusting module 102 determines the current application icon page 60 as a target page. The adjusting module 102 displays the application icons 61 outside of the predetermined region 300 of the target page on the application icon page 60 which is previous or next to the target page, enlarges the application icons 61 of the predetermined region 300 of the target page, displays the enlarged application icons 61 of the predetermined region 300 on the entire target page, and increases the distances among the enlarged application icons 61 on the target page.

The adjusting module 102 further determines the application icons page 60 which is previous or next to the target page as a new target page and makes the same adjustment to the new target page until all application pages 60 of the user interface 200 are adjusted. For example, the adjusting module 102 displays the application icons 61 outside of the predetermined region 300 of the new target page on the application icon page 60 which is previous or next to the new target page, enlarges the application icons 61 of the predetermined region 300 of the new target page, displays the enlarged application icons 61 of the predetermined region 300 of the new target page on the entire new target page, and increases the distance among the enlarged application icons 61 on the new target page. The adjusting module 102 further makes the same adjustment to the remaining application icon pages 60 of the user interface 200 until all application icon pages 60 are adjusted.

In at least one embodiment, if the application icons 61 of the application icon page 60, which is previous to or next to the target page (hereinafter, the previous or next application page), are fully arranged on the application icon page 60 and there are application icons 61 of the target page outside of the predetermined region 300 needed to be displayed on the previous or next application icon page 60, the adjusting module 102 displays a number of application icons 61 of the previous or next application icon page 60 on another application icon page 60 which is previous or next to the previous or next application icon page 60 and displays the application icons 61 of the target page outside of the predetermined region 300 on the previous or next application icon page 60.

In the embodiment, after all application icon pages 60 of the user interface 200 are adjusted, if there is at least one application icon 61 which cannot be arranged on one of the application icon pages 60 of the user interface 200, the adjusting module 102 adds a new application icon page 60, and displays the at least one application icon 61 on the new application icon page 60.

FIG. 5 illustrates a diagrammatic view of an embodiment of the diminished application icons 61 on the application icon page 60. In at least one example, when the motion determining module 101 determines that the touch motion on the current application icon page 60 is two touch points moving toward each other, the adjusting module 102 determines the current application icon page 60 as a target page. The adjusting module 102 further diminishes the application icons 61 of the entire target page, displays the diminished application icons 61 on the predetermined region 300 of the target page. In the embodiment, diminishing the application icons 61 of the entire target page means zooming out the application icons 61 of the entire target page. The adjusting module 102 also diminishes a part of the application icons 61 of the previous or next application icon page 60 of the target page and displays the diminished application icons 61 of the previous or next application icon page 60 on the remaining region of the target page outside of the predetermined region 300 and decreases the distances among the diminished application icons 61 arranged on the target page. The adjusting module 102 further determines the previous or next application icon page 60 of the target page as the new target page and makes the same adjustment to the new target page until all application pages 60 of the user interface 200 are adjusted.

In at least one embodiment, when the adjusting module 102 determines the previous or next application icon page 60 of the target page as the new target page, if the application icons 61 of the new target page are not fully arranged on the new target page, then the adjusting module 102 moves the application icons 61 of the previous or next application icon page 60 of the new target page on the new target page until the application icons 61 are fully arranged on the new target page. In the embodiment, after all application icon pages 60 are adjusted, if there are application icon pages 60 without any application icons 61, then the adjusting module 102 deletes the application pages 60 without any application icons 61.

In at least one embodiment, if the current application icon page 60 operated by the user is a home page of the user interface 200, the adjusting module 102 determines the application icon page 60 which is previous to the current application icon page 60 as the target page in sequence. If the current application icon page 60 operated by the user is not the home page of the user interface 200, the adjusting module 102 determines the application icon pages 60 which is previous to the current application icon page 60 as the target page in sequence and determines the application icon pages 60 which is next to the current application icon page 60 as the target page in sequence at the same time.

FIG. 4. illustrates in at least one embodiment, the application icons 61 are arranged on the application icon page 60 as a matrix with r rows and c columns. Therein, r and c are integers, and r=c+1. The predetermined region 300 of the application icon page 60 is a matrix region which includes the application icons 61 of a first row to r-1 row and a first column to c-1 column. Referring to FIG. 4, when the motion determining module 101 determines that the touch motion on the current application icon page 60 is two touch points moving away from each other, the adjusting module 102 determines the current application page 60 as the target page, displays the application icons 61 of the r row and the c column of the target page outside of the predetermined region 300 on the next application icon page 60 of the target page, enlarges the application icons 61 of the first row to the r-1 row and the first column to the c-1 column of the predetermined region 300 of the target page, displays the enlarged application icons 61 of the predetermined region 300 on the entire target page, and increases the distances among the enlarged application icons 61 displayed on the target page.

The adjusting module 102 further determines the next application icon page 60 of the target page as the new target page. Similarly, the adjusting module 102 displays the application icons 61 of the r row and the c column of the new target page on the next application icon page 60 of the new target page, enlarges the application icons 61 of the first row to the r-1 row and the first column to the c-1 column of the new target page, moves the enlarged application icons 61 to the entire new target page, and increase the distances among the enlarged application icons 61 arranged on the new target page. The adjusting module 102 further makes the same adjustment to the remaining application icon pages 60 of the user interface 200 until all application icon pages 60 of the user interface 200 are adjusted.

FIG. 5 illustrates in at least one embodiment, when the motion determining module 101 determines that the touch motion on the current application icon page 60 is two touch points moving toward each other, the adjusting module 102 determines the current application icon page 60 as a target page. The adjusting module 102 diminishes the application icons 61 of the first row to r row and the first column to the c column of the target page, displays the diminished application icons 61 on the predetermined region 300 of the target page. The adjusting module 102 diminishes the application icons 61 of the first row to r row and the first column to the second column of the next application icon page 60, displays the diminished application icons 61 of the next application icon page 60 on the remaining region of the target page outside of the predetermined region 300, and decreases the distances among the diminished application icons 61 arranged on the target page. The adjusting module 102 further determines the next application page 60 of the target page as the new target page.

Similarly, the adjusting module 102 further makes the same adjustment to the remaining application icon pages 60 of the user interface 200 until all application icon pages 60 of the user interface 200 are adjusted.

In at least one embodiment, the predetermined region 300 of the application icon page 60 can be set by the user in response to the operations to the user interface 200 displayed on the display unit 20. In detail, the motion determining module 101 determines a touch position according to the touch signals generated by the display unit 20 when the user touches the display unit 20. The adjusting module 102 further determines the predetermined region 300 of the application icon page 60 according to the touch position determined by the motion determining module 101.

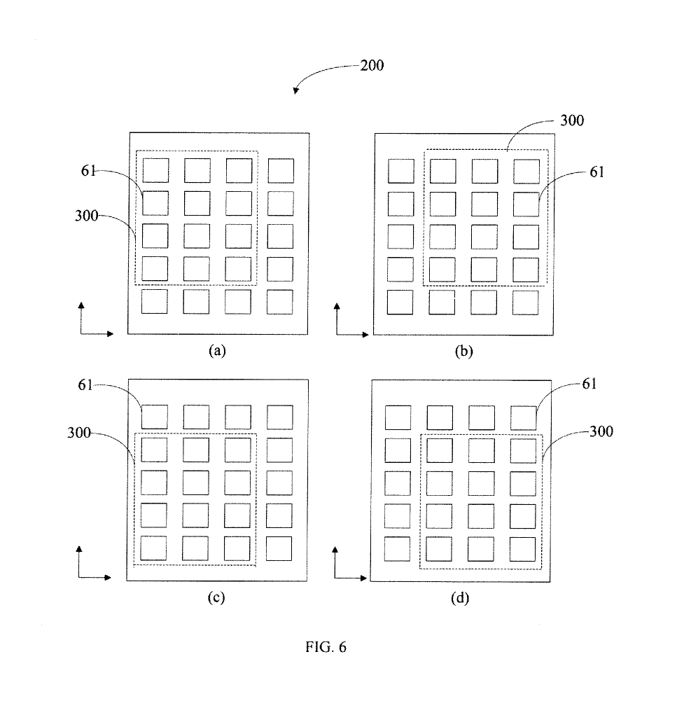

FIG. 6 illustrates a diagrammatic view of an embodiment of the predetermined region 300. In at least one embodiment, the display unit 20 is a rectangle with a width of W and a length of L. The display unit 20 displays at least one application icon page 60 with application icons 61 arranged in matrix with r rows and c columns. Therein, the motion determining module 101 defines a point of the lower left corner of the display unit 20 as an origin, a direction of width of the display unit 20 as a positive direction of X axis, and a direction of length of the display unit 20 as a positive direction of Y axis, thus establishing a coordinate system. When two touch points are slid on the application icon page 60 displayed on the display unit 20, the motion determining module 101 determines coordinates of two initial touch points are (x1, y1) and (x2, y2) according to the touch signals generated by the display unit 20 when the user touches the display unit 20. The two initial coordinate points (x1, y1) and (x2, y2) are the touch positions of the two initial touch points.

The adjusting module 102 determines coordinates of a middle point (a, b) between the two initial coordinate points (x1, y1) and (x2, y2) according to the coordinates of the two initial coordinate points (x1, y1) and (x2, y2). In detail, the adjusting module 102 determines an abscissa value of the middle point (a, b) according to a formula a=(x1+x2)/2, and determines an ordinate value of the middle point (a, b) according to a formula b=(y1+y2)/2. The adjusting module 102 compares coordinates of the determined middle point (a, b) with coordinates of a default point (x0, y0), therein, x0=W/2, y0=L/2. When 0<a<x0 and 0<b<y0, the adjusting module 102 determines the matrix region of the application icon page 60 which includes the application icons 61 of the first row to the r-1 row and the first column to the c-1 column as the predetermined region 300 as shown in the FIG. 6(a). When x0<=a<W and 0<b<y0, the adjusting module 102 determines the matrix region of the application icon page 60 which includes the application icons 61 of the first row to the r-1 row and the second column to the c column as the predetermined region 300 as shown in the FIG. 6(b). When 0<a<x0 and y0<=b<L, the adjusting module 102 determines the matrix region of the application icon page 60 which includes the application icons 61 of the second row to the r row and the second column to the c column as the predetermined region 300 as shown in FIG. 6(c). When x0<=a<W and y0<=b<L, the adjusting module 102 determines the matrix region of the application icon page 60 which includes the application icons 61 of the second row to the r row and the first column to c-1 column as the predetermined region 300 as shown in FIG. 6(d).

In some other embodiments, the predetermined region 300 is a fixed region of the application icon page 60. For example, the predetermined region 300 can be a matrix region of the application icon page 60 which includes the application icons 61 of the first row to the r-1 row and the first column to the c-1 column.

In at least one embodiment, the recording module 103 is used to record operation times of each application corresponding to one application icon 61. The recovery module 104 is used to restore the size of each application icons 61 on application icon page 60 to an initial state in response to the recovery operations to the application icon page 60, and further displays the application icons 61 on the application icon page 60 according to the operation times of the application according to the application icon 61 recorded by the recording module 103. In at least one embodiment, the higher number of operation times of the application corresponding to the application icon 61, the higher the position on the application icon page 60 the application icon 61 is displayed. In one embodiment, the recovery operation is an operation of restarting the electronic device 100, the recovery module 104 restores the size of each application icons 61 of application icon page 60 to the initial state when the recovery module 104 detects the electronic device 100 is restarted and displays the application icon 61 of the application with higher operation times in the front position of the application icon page 60.

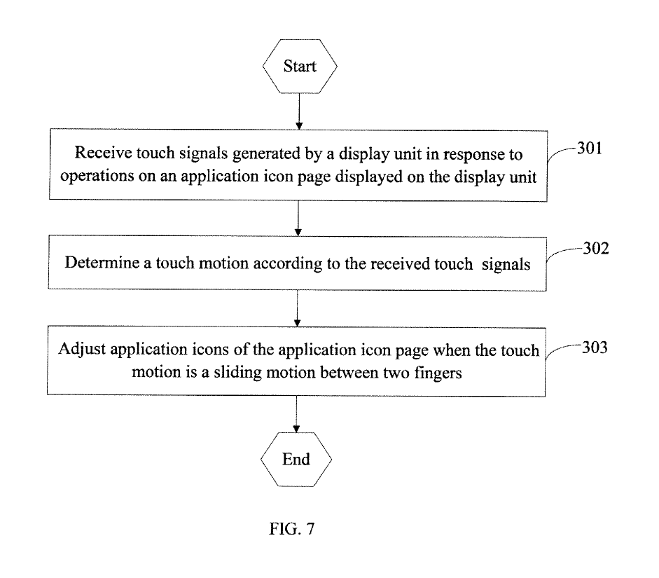

FIG. 7 illustrates a flowchart of an embodiment of a method for adjusting user interface 200. The method is provided by way of example, as there are a variety of ways to carry out the method. The method described below can be carried out using the configurations illustrated in FIG. 1-6, for example, and various elements of these figures are referenced in explaining the example method. Each block shown in FIG. 7 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 301.

At block 301, a motion determining module receives touch signals generated by s display unit in response to operations on an application icon page displayed on the display unit.

At block 302, the motion determining module determines a touch motion according to the received touch signals.

At block 303, an adjusting module adjusts application icons of the application icon page when the touch motion determined by the motion determining module is a sliding motion between two touch points. In at least one embodiment, when the motion determining module determines that the touch motion on the current application icon page is two touch points moving away from each other, the adjusting module displays the application icons outside of a predetermined region of the current application icon page on another application icon page, enlarges the application icons of the predetermined region of the current application icon page, displays the enlarged application icons on the entire application icon page, and adjusts the distances among the enlarged application icons displayed on the entire application icon page.

When the motion determining module determines that the touch motion on the current application icon page is two touch points moving toward each other, the adjusting module diminishes the application icons on the entire application icon page, displays the diminished application icons on the predetermined region of the application icon page. The adjusting module further diminishes a part of the application icons of another application icon page, displays the diminished application icons of the another application icon page on the remaining region outside of the predetermined region of the current application icon page, and adjusts the distances among the diminished application icons arranged on the entire current application icon page.

FIG. 4 illustrates a diagrammatic view of an embodiment of the enlarged application icon on the application icon page. In one example, when the motion determining module determines that the touch motion on the current application icon page is two touch points moving away from each other, the adjusting module determines the current application icon page as a target page. The adjusting module displays the application icons outside of the predetermined region of the target page on the application icon page which is previous or next to the target page, enlarges the application icons of the predetermined region of the target page, displays the enlarged application icons of the predetermined region on the entire target page, and increases the distances among the enlarged application icons on the target page.

The adjusting module further determines the application icons page which is previous or next to the target page as a new target page and makes the same adjustment to the new target page until all application pages of an user interface are adjusted. For example, the adjusting module displays the application icons outside of the predetermined region of the new target page on the application icon page which is previous or next to the new target page, enlarges the application icons of the predetermined region of the new target page, displays the enlarged application icons of the predetermined region of the new target page on the entire new target page, and increases the distance among the enlarged application icons on the new target page. The adjusting module further makes the same adjustment to the remaining application icon pages of the user interface until all application icon pages are adjusted.

FIG. 5 illustrates a diagrammatic view of an embodiment of the diminished application icons on the application icon page. In one example, when the motion determining module determines that the touch motion on the current application icon page is two touch points moving toward each other, the adjusting module determines the current application icon page as a target page. The adjusting module further diminishes the application icons of the entire target page, displays the diminished application icons on the predetermined region of the target page. The adjusting module also diminishes a part of the application icons of the previous or next application icon page of the target page and displays the diminished application icons of the previous or next application icon page on the remaining region of the target page outside of the predetermined region, and decreases the distances among the diminished application icons arranged on the target page. The adjusting module further determines the previous or next application icon page of the target page as the new target page and makes the same adjustment to the new target page until all application pages of the user interface are adjusted.

In at least one embodiment, the method further includes: the motion determining module determines a touch position according to the touch signals generated by the display unit when a user touches the display unit; the adjusting module further determines the predetermined region of the application icon page according to the touch position determined by the motion determining module.

In at least one embodiment, when two touch points are slid on the application icon page displayed on the display unit, the motion determining module determines coordinates of two initial touch points, (x1, y1) and (x2, y2) according to the touch signals generated by the display unit when the user touches the display unit. The two initial coordinate points (x1, y1) and (x2, y2) are the touch positions of the two initial touch points.

The adjusting module determines coordinates of a middle point (a, b) between the two initial coordinate points (x1, y1) and (x2, y2) according to the coordinates of the two initial coordinate points (x1, y1) and (x2, y2). In at least one embodiment, the adjusting module determines an abscissa value of the middle point (a, b) according to a formula a=(x1+x2)/2, and determines an ordinate value of the middle point (a, b) according to a formula b=(y1+y2)/2. The adjusting module compares coordinates of the determined middle point (a, b) with coordinates of a default point (x0, y0), therein, x0=W/2, y0=L/2. When 0<a<x0 and 0<b<y0, the adjusting module determines the matrix region of the application icon page which includes the application icons of the first row to the r-1 row and the first column to the c-1 column as the predetermined region as shown in the FIG. 6(a). When x0<=a<W and 0<b<y0, the adjusting module determines the matrix region of the application icon page which includes the application icons of the first row to the r-1 row and the second column to the c column as the predetermined region as shown in the FIG. 6(b). When 0<a<x0 and y0<=b<L, the adjusting module determines the matrix region of the application icon page which includes the application icons of the second row to the r row and the second column to the c column as the predetermined region as shown in FIG. 6(c). When x0<=a<W and y0<=b<L, the adjusting module determines the matrix region of the application icon page which includes the application icons of the second row to the r row and the first column to c-1 column as the predetermined region as shown in FIG. 6(d).

The method further includes: a recording module records operation times of each application corresponding to one application icon; a recovery module restores the size of each application icons on application icon page to an initial state in response to the recovery operations to the application icon page, further displays the application icons on the application icon page according to the operation times of the application according to the application icon recorded by the recording module.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device for adjusting user interface comprising:
a display unit configured to display an user interface which comprises at least one application icon page, which comprises a plurality of application icons arranged in a multi-row and multi-column matrix, and generate touch signals in response to operations on the application icon page displayed on the display unit; and
at least one processor configured to execute instructions stored on a non-transitory storage medium, the instructions executed by the at least one processor causing the processor to:
receive the touch signals generated by the display unit in response to operations on the application icon page displayed on the display unit;
determine a touch motion according to the received touch signals; and
adjust the application icons of the application icon page when the touch motion is a sliding motion between two touch points.

2. The electronic device as according to claim 1, wherein the application icon page comprises a predetermined region configured to display partial application icons of the corresponding application icon page.

3. The electronic device as according to claim 2, wherein when determining that the touch motion on the current application icon is two touch points moving away from each other, the instructions executed by the at least one processor causing the processor to display the application icons outside of the predetermined region of the current application icon page on another application icon page, enlarge the application icons of the predetermined region of the current application icon page, display the enlarged application icons on the entire current application icon page, and adjust the distances among the enlarged application icons.

4. The electronic device as according to claim 3, wherein when determining that the touch motion on the current application icon page is two touch points moving away from each other, the instructions executed by the at least one processor causing the processor to determine the current application icon page as a target page, display the application icons outside of the predetermined region of the target page on the application icon page which is previous or next to the target page, enlarge the application icons of the predetermined region of the target page, display the enlarged application icons of the predetermined region on the entire target page, and increase the distances among the enlarged application icons on the target page; the instructions executed by the at least one processor further causing the processor to determine the application icons page which is previous or next to the target page as a new target page, and makes the same adjustment to the new target page until all application pages of the user interface are adjusted.

5. The electronic device as according to claim 2, wherein when determining that the touch motion on the current application icon page is two touch points moving toward each other, the instructions executed by the at least one processor causing the processor to diminish the application icons on the entire application icon page, display the diminished application icons on the predetermined region of the application icon page, diminish a part of the application icons of another application icon page, display the diminished application icons of the another application icon page on the remaining region outside of the predetermined region of the current application icon page, and adjust the distances among the diminished application icons displayed on the entire current application icon page.

6. The electronic device according to claim 5, wherein when determining that the touch motion on the current application icon page is two touch points moving toward each other, the instructions executed by the at least one processor causing the processor to determine the current application icon page as a target page, diminish the application icons of the entire target page, display the diminished application icons on the predetermined region of the target page, diminish a part of the application icons of the previous or next application icon page of the target page and displays the diminished application icons of the previous or next application icon page on the remaining region of the target page outside of the predetermined region, and decrease the distances among the diminished application icons arranged on the target page; the instructions executed by the at least one processor further causing the processor to determines the previous or next application icon page of the target page as the new target page and makes the same adjustment to the new target page until all application pages of the user interface are adjusted.

7. The electronic device according to claim 2, wherein the instructions executed by the at least one processor causing the processor to determine a touch position according to the touch signals generated by the display unit when the user touches the display unit, determine the predetermined region of the application icon page according to the touch position.

8. The electronic device according to claim 1, wherein the instructions executed by the at least one processor causing the processor to:
record operation times of each application corresponding to one application icon; and restore the size of each application icons displayed on application icon page to an initial state in response to the recovery operations to the application icon page, and display the application icons on the application icon page according to the operation times of the application according to the application icon.

9. A method for adjusting user interface, comprising:
receiving touch signals generated by a display unit in response to operations on an application icon page displayed on the display unit;
determining a touch motion according to the received touch signals; and
adjusting application icons of the application icon page when the touch motion is a sliding motion between two touch points.

10. The method as according to claim 9, wherein the application icon page comprises a predetermined region configured to display partial application icons of the corresponding application icon page.

11. The method as according to claim 10, wherein the step of adjusting the application icons of the application icon page when the touch motion is the sliding motion between two touch points comprising:
when determining that the touch motion on the current application icon is two touch points moving away from each other, displaying the application icons outside of the predetermined region of the current application icon page on another application icon page, enlarging the application icons of the predetermined region of the current application icon page, displaying the enlarged application icons on the entire current application icon page, and adjusting the distances among the enlarged application icons.

12. The method as according to claim 11, wherein the method further comprising:
when determining that the touch motion on the current application icon page is two touch points moving away from each other, determining the current application icon page as a target page, displaying the application icons outside of the predetermined region of the target page on the application icon page which is previous or next to the target page, enlarging the application icons of the predetermined region of the target page, displaying the enlarged application icons of the predetermined region on the entire target page, increasing the distances among the enlarged application icons on the target page, determining the application icons page which is previous or next to the target page as a new target page, and making the same adjustment to the new target page until all application pages of the user interface are adjusted.

13. The method as according to claim 10, wherein the step of adjusting the application icons of the application icon page when the touch motion is the sliding motion between two touch points comprising:
when determining that the touch motion on the current application icon page is two touch points moving toward to each other, diminishing the application icons on the entire application icon page, displaying the diminished application icons on the predetermined region of the application icon page, diminishing a part of the application icons of another application icon page, displaying the diminished application icons of the another application icon page on the remaining region outside of the predetermined region of the current application icon page, and adjusting the distances among the diminished application icons displayed on the entire current application icon page.

14. The method as according to claim 13, wherein the method further comprising:
when determining that the touch motion on the current application icon page is two touch points moving toward each other, determining the current application icon page as a target page, diminishing the application icons of the entire target page, displaying the diminished application icons on the predetermined region of the target page, diminishing a part of the application icons of the previous or next application icon page of the target page and displaying the diminished application icons of the previous or next application icon page on the remaining region of the target page outside of the predetermined region, decreasing the distances among the diminished application icons arranged on the target page, determining the previous or next application icon page of the target page as the new target page and making the same adjustment to the new target page until all application pages of the user interface are adjusted.

15. The method as according to claim 10, wherein the method further comprising:
determining a touch position according to the touch signals generated by the display unit when an user touches the display unit; and
determining the predetermined region of the application icon page according to the touch position

16. The method as according to claim 9, wherein the method further comprising:
recording operation times of each application corresponding to one application icon; and
restoring the size of each application icons displayed on application icon page to an initial state in response to the recovery operations to the application icon page, and displaying the application icons on the application icon page according to the operation times of the application according to the application icon.
